(19) United States
(12) Patent Application Publication
(10) Pub. No.: US 2013/0135184 A1
(43) Pub. Date: May 30, 2013

(54) ENCAPSULATED ARRAYS OF ELECTROMECHANICAL SYSTEMS DEVICES

(71) Applicants: Ming-Hau Tung, San Francisco, CA (US); Rihui He, San Jose, CA (US); Jon Bradley Lasiter, Stockton, CA (US)

(72) Inventors: Ming-Hau Tung, San Francisco, CA (US); Rihui He, San Jose, CA (US); Jon Bradley Lasiter, Stockton, CA (US)

(73) Assignee: QUALCOMM MEMS TECHNOLOGIES, INC., San Diego, CA (US)

(21) Appl. No.: 13/306,753

(22) Filed: Nov. 29, 2011

(51) Int. Cl. G09G 3/34; B05D 5/12; G02B 26/00

(52) U.S. Cl. 345/84; 359/291; 427/100

(57) ABSTRACT

This disclosure provides systems, methods and apparatus for encapsulating electromechanical systems devices. In one aspect, large arrays of electromechanical systems devices can be encapsulated. In one aspect the encapsulation includes an encapsulation layer supported over the electromechanical systems devices by encapsulation layer supports. The encapsulation layer can also include a plurality of orifices. The orifices can be sealed such that the electromechanical systems devices below are not damaged.

### TECHNICAL FIELD

This disclosure relates to electromechanical systems devices and more particularly to encapsulated arrays of electromechanical systems devices and methods for fabricating the same.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Some electromechanical systems devices include a layer that protects a mechanical element. For example, a mechanical element can be protected by a layer that may be referred to as an “encapsulation layer” or a “shell layer” over the electromechanical systems device. Encapsulation can protect electromechanical devices from environmental hazards, such as moisture and mechanical shock.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems device package. The electromechanical systems device package can include a substrate having an array of movable electrodes spaced apart from the substrate by a first gap and suspended above the substrate by a plurality of posts. A space can be present between adjacent movable electrodes in the array. An encapsulation layer can be spaced apart from the array of movable electrodes by a second gap and the encapsulation layer can include a plurality of orifices positioned over one or more of the plurality of posts or the space between adjacent movable electrodes. A sealing layer can be disposed over the encapsulation layer and thereby seal the orifices. In one aspect, a plurality of orifices can be positioned over a plurality of posts. In one aspect a plurality of orifices can be positioned over the space between adjacent movable electrodes. In one aspect, the plurality of posts are arranged into an array of rows and columns. The plurality of orifices can be positioned over alternating posts in the array. In one aspect, the space between adjacent movable electrodes is an optically inactive space.

Another innovative aspect of the subject matter described in this disclosure can be implemented in a method of forming an electromechanical systems device package. The method can include forming a first sacrificial layer on a substrate, forming an array of movable electrodes above the first sacrificial layer, forming a second sacrificial layer above the array of movable electrodes, depositing an encapsulation layer above the second sacrificial layer, releasing the first sacrificial layer and the second sacrificial layer through the plurality of orifices, and sealing the plurality of orifices in the encapsulation layer. The encapsulation layer has a plurality of orifices located above the posts or located above the space present between adjacent movable electrodes. In one aspect, the movable electrodes are supported by posts and a space is present between adjacent movable electrodes. In one aspect, sealing the orifices includes depositing material through the orifices and onto the anchor regions below.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example top view schematic illustration of a portion of a sealed device having an array of encapsulated interferometric modulators.

FIG. 9B shows an example plan view schematic illustration of a portion of the encapsulated IMOD display device from FIG. 9A with the sealing layer and encapsulation layer removed to illustrate the relative positions of the internal components.

FIG. 9C shows a cross-sectional view schematic illustration of the encapsulated IMOD display device 900 of Figure.

FIGS. 10A-10D show examples of cross-sectional schematic illustrations of various stages in a method of making the device shown in FIG. 9A along the line 9C-9C.

FIG. 11 shows an example of a flow diagram illustrating a manufacturing process for forming an encapsulated array of electromechanical systems devices.

FIG. 12 shows an example top view schematic illustration of a portion of an alternate implementation of an interferometric modulator device.

FIG. 13 shows an example top view schematic illustration of a portion of an interferometric modulator device including an array of encapsulated interferometric modulators.

FIG. 14 shows an example enlarged top view schematic illustration of a portion of an anchor area of the interferometric modulator device in FIG. 13.

FIG. 14A shows an example cross-section of a portion of an anchor area of the interferometric modulator device across the line 14A-14A after etching the orifice.

FIG. 14B shows an example cross-section of a portion of an anchor area of the interferometric modulator device across the line 14B-14B before etching the orifice.

FIG. 14B′ shows an example cross-section of a portion of an anchor area of the interferometric modulator device across the line 14B-14B after etching the orifice.

FIG. 15 shows an example top view schematic illustration of a portion of an interferometric modulator device including an array of encapsulated interferometric modulators.

FIG. 16 shows an example top view schematic illustration of a portion of an interferometric modulator device including an array of encapsulated interferometric modulators.

FIG. 17 shows an example top view schematic illustration of a portion of an interferometric modulator device including an array of encapsulated interferometric modulators.

FIG. 18 shows an example top view schematic illustration of a portion of an interferometric modulator device including an array of encapsulated interferometric modulators.

FIG. 19 shows a partial cross-sectional schematic illustration of an encapsulated two-electrode interferometric modulator device.

FIGS. 20A and 20B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some implementations include a process for forming electromechanical systems (EMS) devices that have release orifices formed in specific patterns in an encapsulation layer of the electromechanical systems device. The electromechanical systems devices may include encapsulation posts that are formed on anchor regions of the electromechanical systems device. Such encapsulation posts may impart structural strength and rigidity to the encapsulation layer that may be layered above the encapsulation post. In some implementations, release orifices are formed in the encapsulation layer and oriented so that the release orifices are created above, adjacent, or in a predetermined geometric pattern around the position where an encapsulation post contacts and/or transitions to the encapsulation layer. The release orifices may be sized, shaped, and/or positioned in the encapsulation layer to provide a release pathway for introducing release gasses into the electromechanical systems device to remove previously deposited sacrificial layers.

In some implementations, the one or more release orifices are located in an encapsulation post. For example, a series of two, three, four, five, or more release orifices may be formed through the encapsulation layer at a position that circumscribes the contact position where the encapsulation post contacts the encapsulation layer. In other implementations, a predetermined pattern of release orifices is formed in the encapsulation layer so that the predetermined pattern of orifices are located above non-movable elements within the electromechanical systems device. Non-movable elements would include those portions of the electromechanical systems device that generally don't change position as the electromechanical systems device is operated. For example, stationary walls, posts, non-movable thin film layers, and similar components of the electromechanical systems device would be considered “non-movable” as used herein.

In some implementations, the release orifices are disposed in a predetermined spatial configuration in the encapsulation layer so that any release gasses that traverse the release orifices will be distributed more uniformly throughout the electromechanical systems device. For example, the release orifices may be positioned throughout the encapsulation layer rather than positioned about the periphery of the encapsulation layer. In this way, the release gasses can remove more sacrificial material in a shorter time period.

A predetermined spatial configuration may include positioning the release orifices at regular intervals in a specific pattern, such as rows and columns, across the surface of the encapsulation layer. In some implementations, the release orifices are about 100 Å-100 μm away from their closest neighbor. In one implementation, each row of release orifices may be offset from the other rows to create a predetermined spatial configuration. In some implementations, the predetermined spatial configuration is disposed above a movable element, such as a movable mirror of the electromechanical systems device. In another implementation, the predetermined spatial configuration is disposed above the non-movable elements of an electromechanical systems device. Sacrificial material can be released through such release orifices and the release orifices can then be sealed, completing a hermetic encapsulation of the electromechanical systems devices below.

Particular implementations of the subject matter described in this disclosure can be implemented to realize one or more of the following potential advantages. For example, forming release orifices in predetermined configurations as discussed above and below may prevent release gasses from adversely affecting the performance of sensitive movable elements within the electromechanical systems device. Increasing the number of orifices and/or positioning orifices throughout the array may decrease the pressure of the release gas. In addition, providing the release orifices in such a configuration may ensure that any sealant material used to seal the release orifices does not harm movable elements within the electromechanical systems device. In addition, using the methods described herein may allow manufacture of larger electromechanical systems devices since the predetermined configurations of release orifices described herein may allow larger sacrificial layers to be produced and released within an electromechanical systems device. Accordingly, the specific configuration of release orifices as described herein may lead to more efficient release of sacrificial layers. In addition, positioning release orifices in predetermined spatial positions within the encapsulation layer may decrease the release time, thereby lowering manufacturing times.

One example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

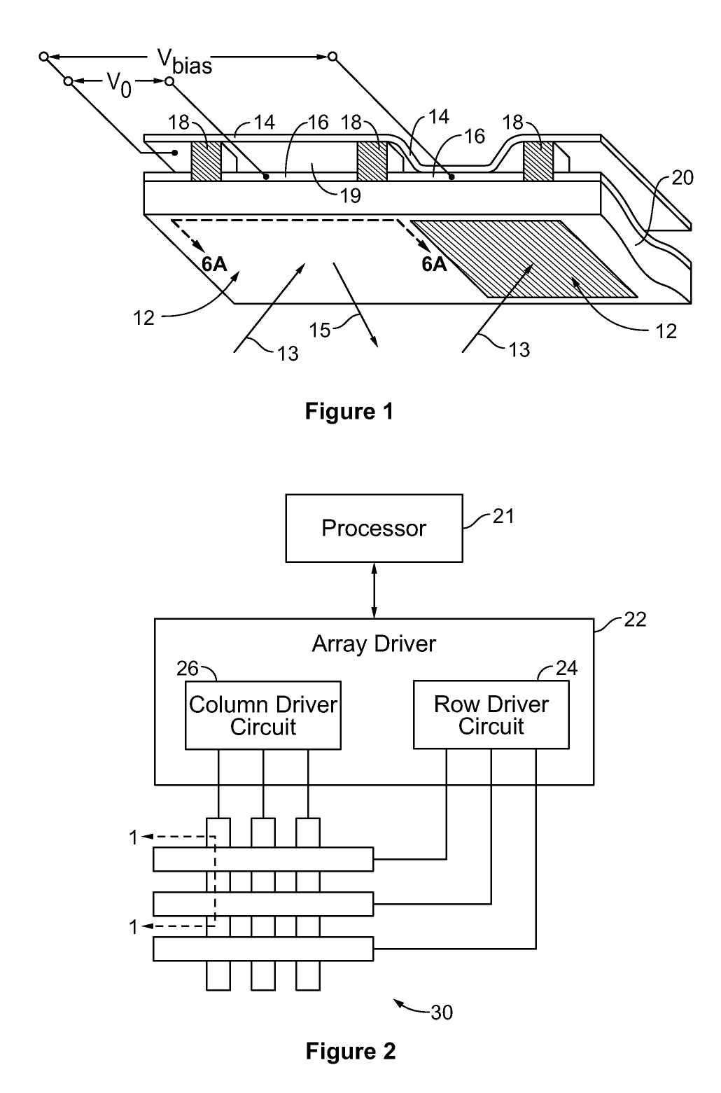

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

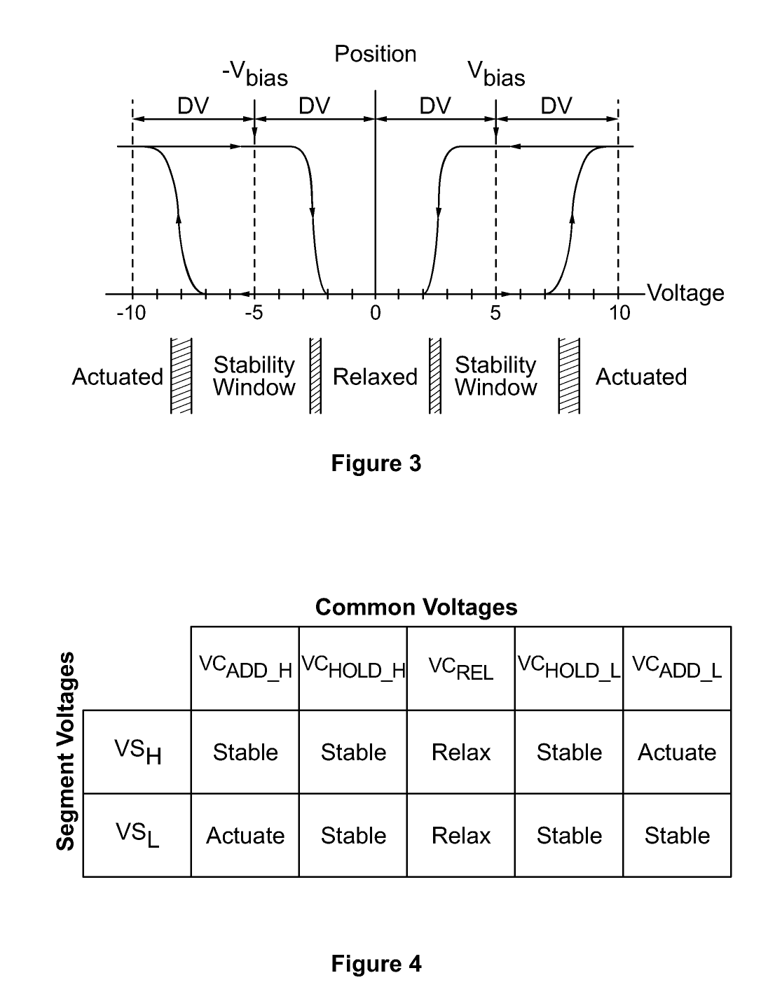

The details of the structure of interferometric modulators that operate in accordance with the principles set forth above may vary widely. For example, the movable reflective layers 14 of each IMOD 12 may be attached to supports at the corners only, for example, on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

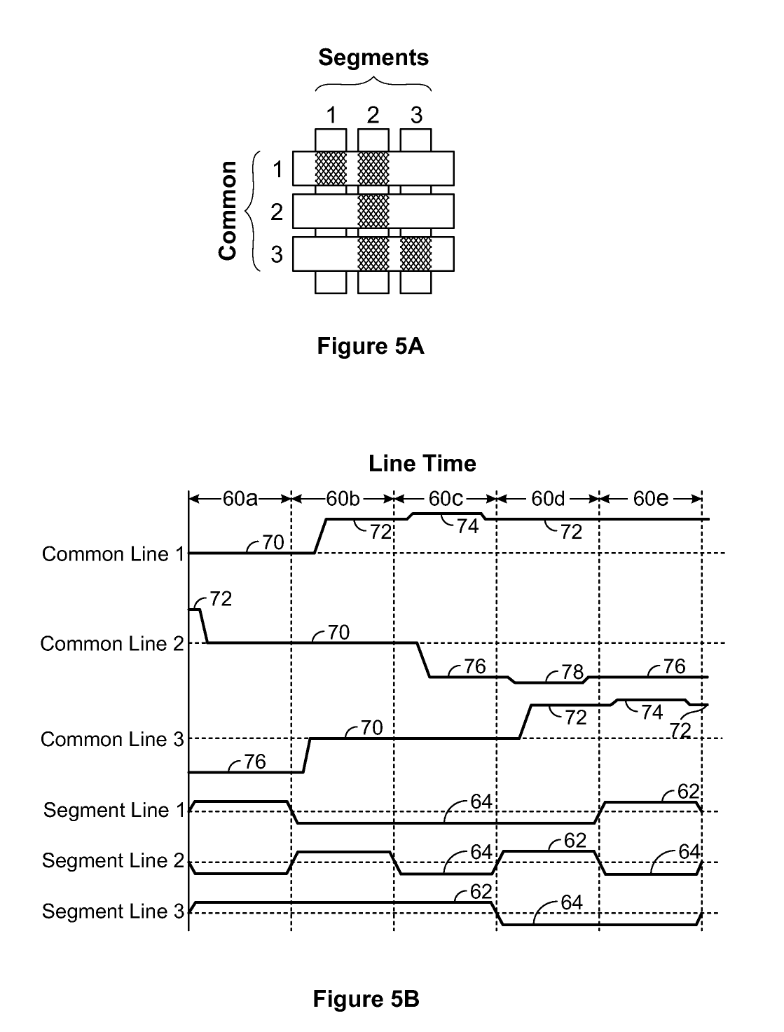

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

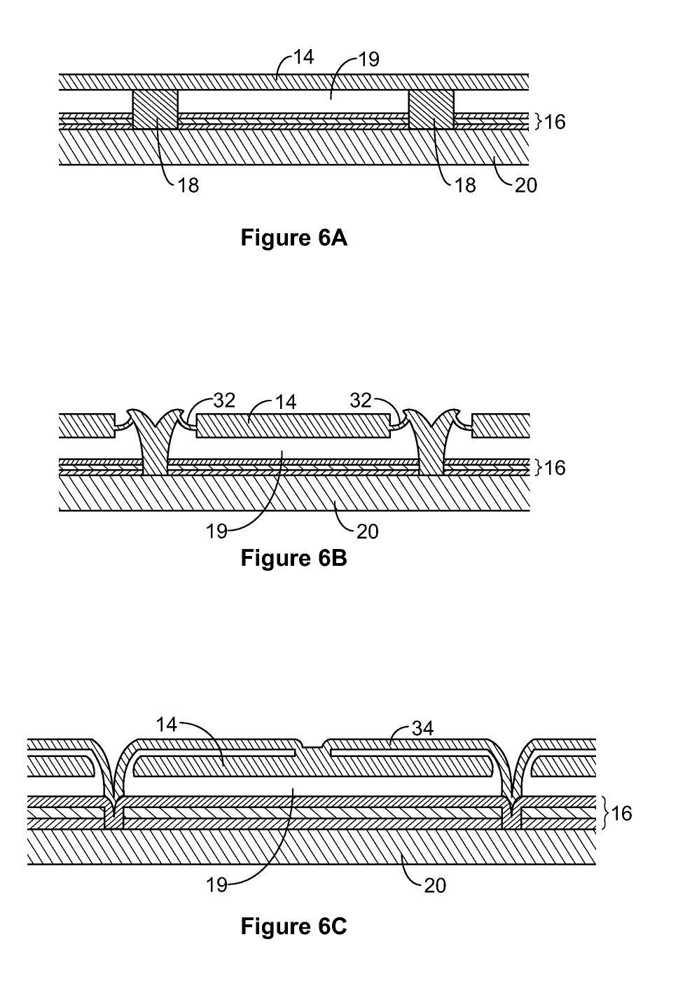

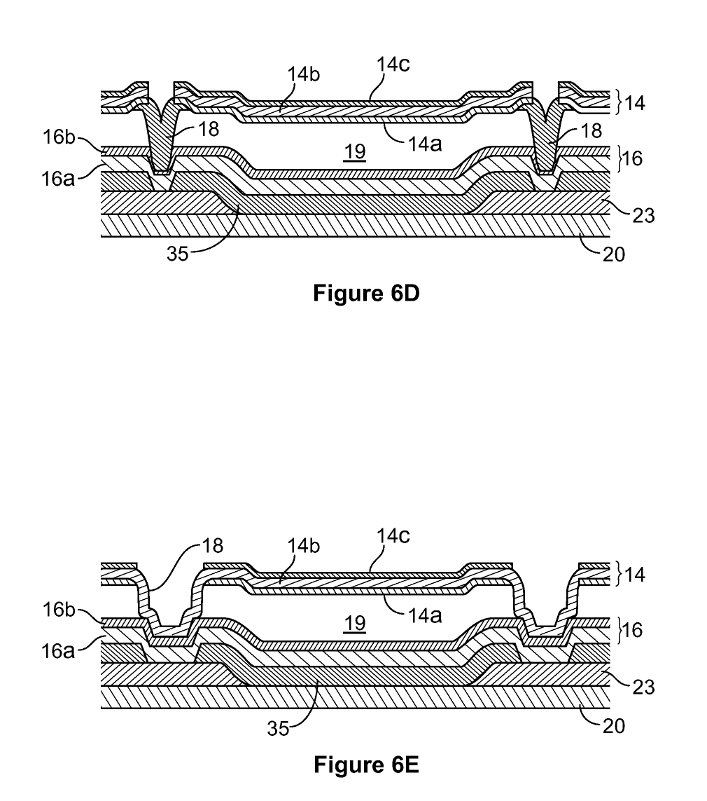

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

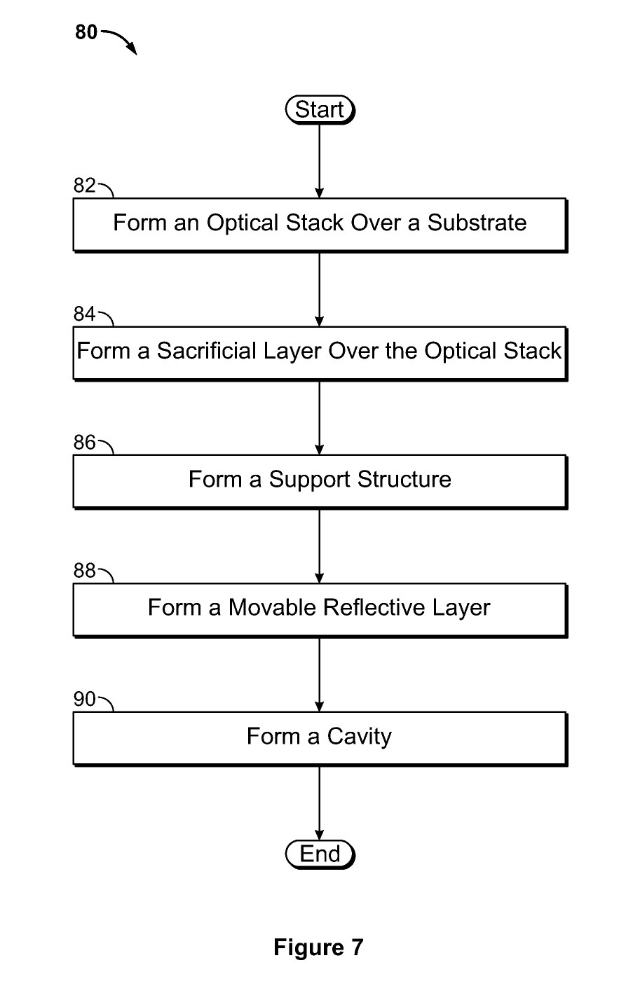

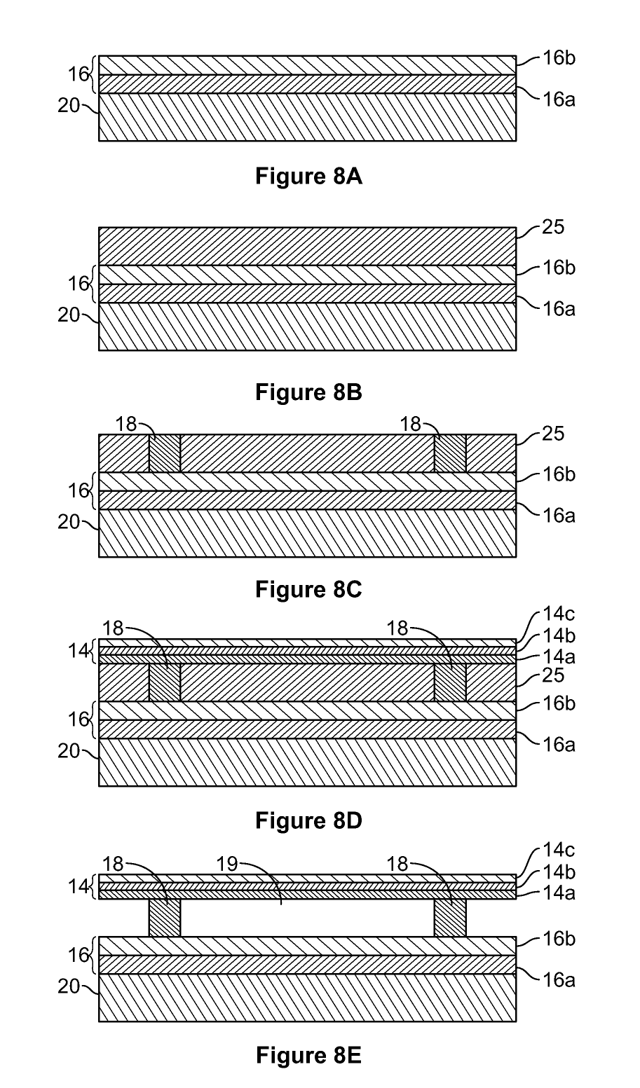

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

### Thin Film Encapsulation for Arrays of Electromechanical Devices

Electromechanical systems devices, such as those shown in FIGS. 6A-6E, can be encapsulated to protect the electromechanical systems devices from environmental hazards, such as moisture and mechanical shock. Encapsulation techniques can include macro-encapsulation and thin-film encapsulation. A thin-film encapsulation process can involve depositing one or more thin film layers over the MEMS device, while macro-encapsulation involves joining and/or bonding a cover to a device provided on a substrate to form a package. In some implementations, a thin-film encapsulation layer can function as a substrate for additional circuit elements formed above the encapsulation layer.

While particular structures and processes are described as suitable for an IMOD implementation, it will be understood that for other electromechanical systems implementations (such as electromechanical switches, optical filters, accelerometers, etc.), different materials can be used or parts modified, omitted, or added. Additionally, in some IMOD display applications, the drawings may not reflect an accurate scale, for example, the horizontal distance between mechanical layers of adjacent devices may be about 3-10 μm, and the mechanical layers may each be about 30-50 μm long in the horizontal direction. As another example, the distance between pixels, or mechanical layers, in adjacent devices can be about 100 μm in certain radio frequency MEMS applications (e.g., switches, switched capacitors, varactors, resonators, etc.) while each mechanical layer can be about 30-50 μm long. As a further example, the relative gap sizes between layers may not be drawn to scale.

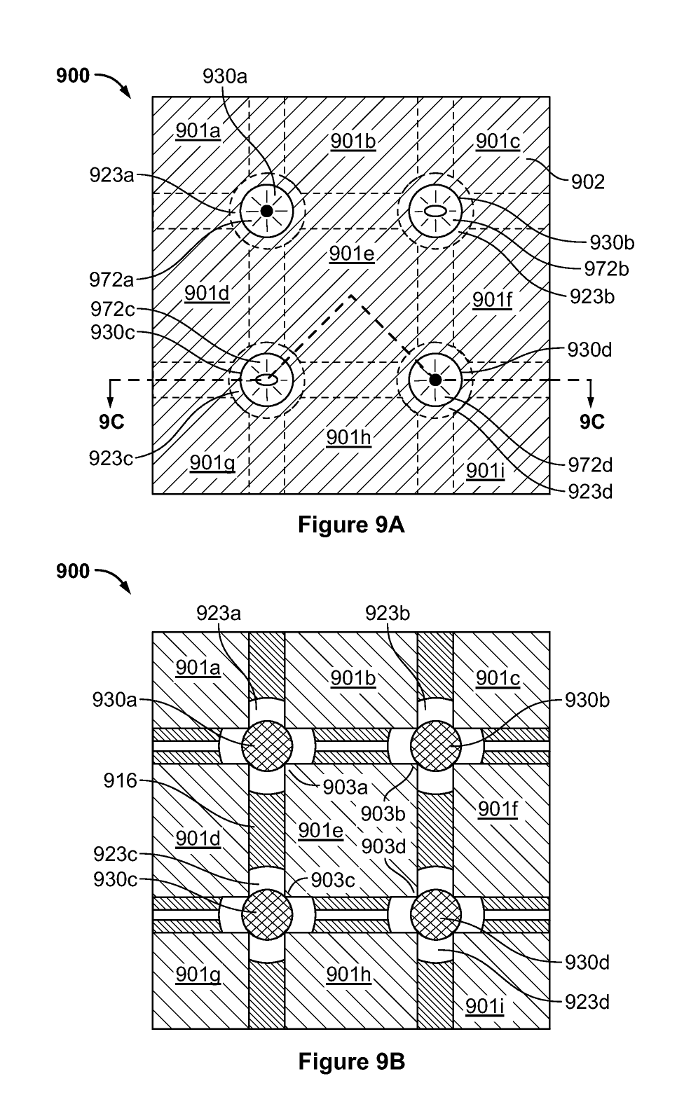

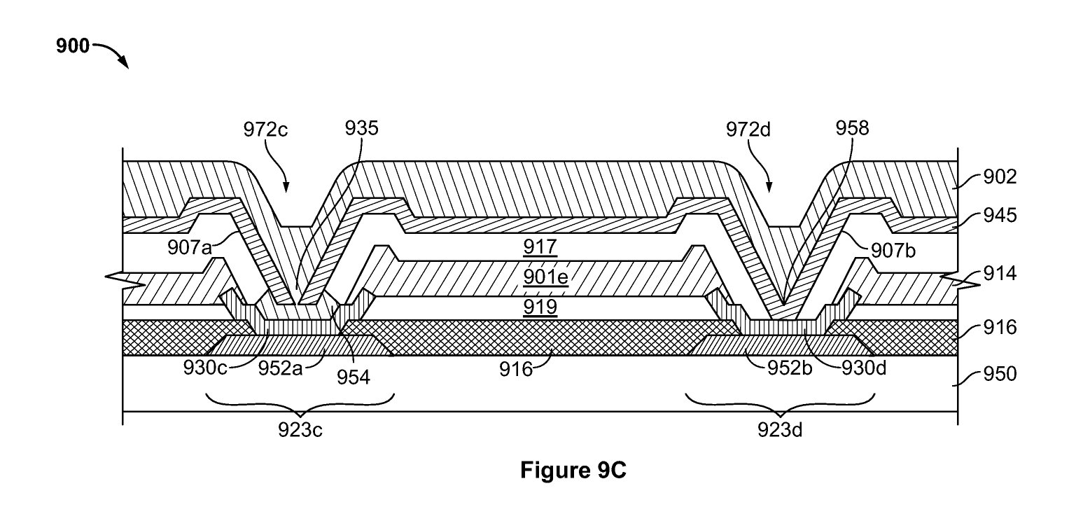

FIG. 9A shows an example top view schematic illustration of a portion of a sealed electromechanical systems device including an array of encapsulated IMODs. As shown, an encapsulated IMOD display device 900 includes a sealing layer 902 disposed over an encapsulation layer (not shown). The sealing layer 902 and the process of forming the encapsulated IMOD display device 900 will be described in detail below. For illustrative purposes, portions of the IMOD that reside below the sealing layer 902 are shown in dashed lines to indicate the relative positions of sealant troughs 972a-972d in the sealing layer 902 above with respect to the IMOD below. The sealing troughs 972a-972d can be formed by recesses in the encapsulation layer.

The sealant troughs 972a-972d are formed above posts 930a-930d which are mounted to anchor regions 923a-923d and in between a series of movable mirrors 901a-901i. Referring to the movable mirror 901e by way of example, the posts 930a-930d provide support to the movable mirrors 901e at the corners and the movable mirror 901e is otherwise free standing. The IMOD structures will be described with reference to FIG. 9B which illustrates the lower layers of the encapsulated IMOD display device 900 that reside below the sealing layer 902.

FIG. 9B shows an example plan view schematic illustration of a portion of the encapsulated IMOD display device 900 from FIG. 9A with the sealing layer and encapsulation layer removed to illustrate the relative positions of the internal components. The movable mirrors 901a-901i are shown as arranged in an array of rows and columns and are roughly square-shaped. The following description pertains to movable mirror 901e, but is equally applicable to any of the other movable mirrors within the encapsulated IMOD display device 900. As shown, the movable mirror 901e is disposed above an optical stack 916. A gap (not shown) is provided between the optical stack 916 and the movable mirror 901e to allow the movable mirror 901e to move within the encapsulated IMOD display device 900.

Continuing with FIG. 9B, the movable mirror 901e is shown as anchored to the four posts 930a-930d near the corners 903a-903d of the movable mirror. The movable mirrors can be supported over more area of the post than is illustrated. In some implementations, the posts 930a-930d are integrated with the movable mirrors 901a-901i such that the movable mirrors are self-supported. The anchor regions 923a-923d may be areas where posts 920a-920d are anchored on or over the substrate and/or areas where self-supported movable mirrors are anchored on or over the substrate. The anchor regions 923a-923d may include optically inactive areas of the encapsulated IMOD display device 900.

Upon review of FIG. 9B one can appreciate the positioning of the sealant troughs 972a-972d from FIG. 9A with respect to the anchor regions 923a-923d and posts 930a-930d shown in FIG. 9B. For example, one can appreciate that sealant trough 972a shown on FIG. 9A is positioned above post 930a and in anchor region 923a.

FIG. 9C shows a cross-sectional view schematic illustration of the encapsulated IMOD display device 900 of FIG. 9A along the line 9C-9C. As shown, the device 900 is formed on a substrate 950. The substrate 950 can include a variety of materials, including glass or a transparent polymeric material which permits images to be viewed through the substrate 950. In some implementations, the substrate 950 is substantially transparent to visible light, but the substrate 950 does not need to be highly transparent to all wavelengths of light to be within the scope of the described implementations.

A black mask layer 952a and 952b is disposed on the substrate 950 in an optically inactive region, such as in the anchor regions 923c and 923d. The optical stack 916 is formed above the substrate 950 and also above a first black mask portion 952a and a second black mask portion 952b. In some implementations, the black mask portions 952a and 952b are conductive and serve as bus lines. Although the optical stack 916 is shown touching the black mask portions 952a and 952b, it is understood that in implementations where the black mask portions 952a and 952b serve as bus lines, depending on how the signals are to be routed to the optical stack 916 of any given device, the optical stack 916 may or may not be electrically connected to black mask portions 952a and 952b. In some implementations, the optical stack 916 is not located over the black mask portions 952a and 952b but rather abuts the black mask portions 952a and 952b. In some implementations the optical stack 916 is completely/continuously below the post region 930c, 930d. A first post 930c and a second post 930d are formed above the black mask portions 952a and 952b and support the movable mirror 901e spaced apart from the optical stack 916 by a first gap 919. In some implementations, the posts 930c and 930d may be in the form of a bowl shaped structure positioned on at least a portion of the black mask portions 952a and 952b.

An encapsulation layer 945 is deposited over the movable mirror 901e and spaced away from the movable mirror 901e by a second gap 912. The encapsulation layer 945 is formed to encapsulate the movable mirrors 901a-901i within the device 900. The encapsulation layer 945 has a plurality of funnel-shaped portions 907a and 907b, each of which may be formed above a post. For example, funnel-shaped portion 907a is disposed above post 930c while funnel-shaped portion 907b is formed above, and contacts, post 930d. The funnel-shaped portion 907a in the encapsulation layer 945 includes a previously open orifice 935 at its tip, and is located directly above the post 930c in anchor region 923c.

The encapsulation layer 945 can remain suspended above the movable mirror 901e by using a plurality of funnel shaped portions formed into encapsulation layer supports, such as encapsulation layer support 958, to contact a plurality of posts within the device. The number of encapsulation layer supports that contact the posts or anchor regions can be determined so that the encapsulation layer 945 will remain suspended above the movable mirrors without risk of sagging or cracking.

In order to seal the orifices after the release of sacrificial material, the sealing layer 902 is deposited over the encapsulation layer 945 so that at least a portion of the sealing layer 902 enters and seals the orifices in the encapsulation layer 945. For example, as shown in FIG. 9C, at least a portion 954 of the sealing layer 902 can flow through the orifice 935 and contact the post 930c. Thus, at least a portion of the post 930c can serve as an area configured to receive sealing material from the sealing layer 902.

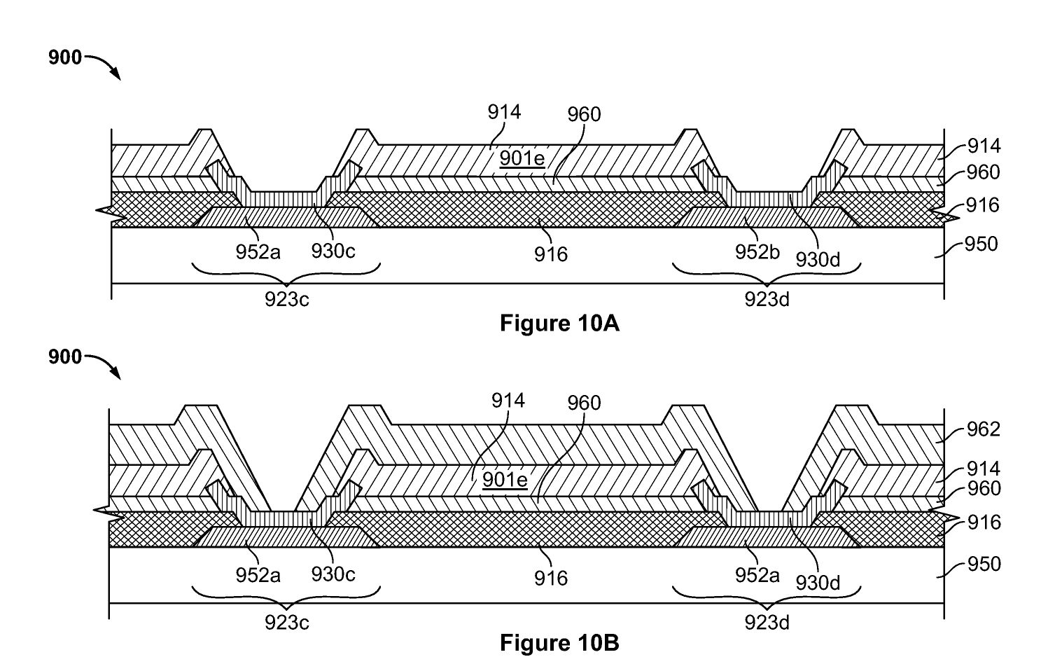

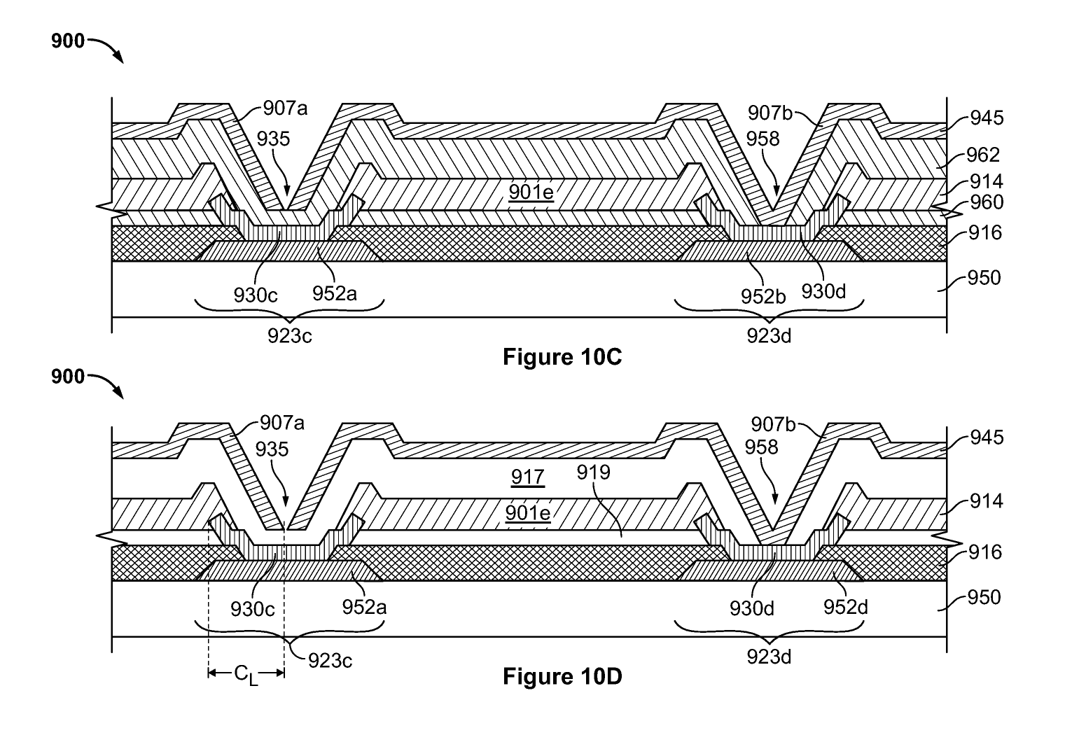

FIGS. 10A-10D show examples of cross-sectional schematic illustrations of various stages in a method of making the device shown in FIG. 9A along the line 9C-9C. The encapsulated IMOD display device 900 can be formed using a variety of methods, including deposition and patterning techniques. As used herein, and as will be understood by one having ordinary skill in the art, the term “patterned” refers to masking as well as etching processes.

As indicated in FIG. 10A, the device 900 starts with the substrate 950. The black mask portions 952a and 952b are then patterned and layered onto the substrate 950. The black mask portions 952a and 952b may include a series of sub-layers (not shown). In some implementations the black mask portions 952a and 952b include an optical absorber sub-layer including a MoCr layer having a thickness in the range of about 30-80 Å, a dielectric sub-layer, including a SiO2 layer having a thickness in the range of about 500-1,000 Å, and a bussing layer having an aluminum silicon (AlSi) layer with a thickness in the range of about 100-6,000 Å.

After the black mask portions 952a and 952b had been formed on the substrate 950, the optical stack 916 is then patterned onto the substrate 950 and the black mask portions 952a and 952b. The optical stack 916 can be electrically conductive, partially transparent and partially reflective, and can include a stationary electrode for providing the electrostatic operation for the interferometric modulator device. In some implementations, some or all of the layers of the optical stack 916, including, for example, the stationary electrode, are patterned into parallel strips, and may form row electrodes in the IMOD display device 900. In some implementations, the optical stack 916 includes a MoCr layer having a thickness in the range of about 30-80 Å, an Aluminum Oxide (AlOₓ) layer having a thickness in the range of about 50-902 Å, and a SiO₂ layer having of thickness in the range of about 250-500 Å.

Formed on top of the optical stack 916 is a first sacrificial layer 960. The first sacrificial layer 960 is a temporary layer, and is removed later during processing to form the gap 919. In some implementations, the first sacrificial layer 960 can include more than one layer, or includes a layer of varying thickness, to aid in the formation of a display device having a multitude of resonant optical gaps.

The first sacrificial layer 960 may be made of a fluorine-etchable material such as Mo, tungsten (W), or a-Si, in a thickness selected to provide, after subsequent removal, a first gap 919 having the desired size (see FIG. 9C). The thickness or vertical height of the first sacrificial layer 960 can be in the range of about 400-4,000 Å, for example, from less than about 2,000 Å for a (first-order) green IMOD, about 2,000 Å to about 3,000 Å for a red IMOD, and about 3,000 Å or more for a (second-order) blue IMOD. After removal of the sacrificial layer, the gap height can also be in the range of about 400-4,000 Å. Deposition of the first sacrificial layer 960 over the optical stack 916 can be carried out using deposition techniques such as PVD, PECVD, thermal CVD, spin-coating or other techniques known by a person having ordinary skill in the art.

Formed above the black mask portions 952a and 952b are the posts 930c and 930d which are formed to overlap a portion of the optical stack 916 and the first sacrificial layer 960. The posts 930c and 930d can be formed from inorganic and insulating material such as SiO₂ and/or SiON. In some implementations, the thickness of the posts 930c and 930d can be in the range of about 500-10,000 Å, for example, about 1,500 Å.

The movable mirror 901e is patterned over the first sacrificial layer 960 and at least a portion of the posts 930c and 930d. In some implementations with a self-supporting mirror, not posts are deposited, but rather the movable mirror 901 is conformally formed over the first sacrificial layer 960 and directly anchored to the substrate 950. The movable mirror 901e may include one or more sub-layers. For example, the movable mirror 901e may include a reflective sub-layer, a support layer, and/or a conductive layer, as illustrated in the implementations shown above in FIGS. 6D and 6E. In some implementations, the support layer is a dielectric layer of, for example, SiON. The reflective layer and the conductive layer can include, for example, metallic materials (such as aluminum-copper (AlCu) with about 0.5% Cu by weight). Conductors above and below the dielectric support layer can balance stresses and provide enhanced conduction. In some other implementations, movable mirror 901e can include a single layer, such as the movable reflective layer 14 shown in FIG. 6A.

The movable mirror 901e can be formed by a variety of techniques, such as atomic layer deposition (ALD). The total thickness of the movable mirror 901e can be in the range of about 1,000-4,000 Å. In some implementations, the thickness of the movable mirror 901e is in the range of about 600-800 Å. In some implementations, the mechanical layer is about 3,000 Å thick. One having ordinary skill in the art can appreciate that the movable mirror 901e can include a variety of layers depending upon the electromechanical systems device functions. For example, the movable mirror 901e can be made flexible and conductive to function as a movable electrode, as shown for example in FIG. 6A, or to support a separate movable electrode, as shown for example in FIG. 6C. As illustrated, the movable mirror 901e is attached to posts 930c and 930d to keep at least a portion of the movable mirror 901e spaced from the optical stack 916 after the first sacrificial layer 960 is removed from underneath the movable mirror 901e.

Referring now to FIG. 10B, a second sacrificial layer 962 is deposited over the movable mirror layer 901e and a portion of the posts 930c and 930d. The second sacrificial layer 962 can have a thickness in the range of about 500-50,000 Å, for example, about 7,500 Å or less. The second sacrificial layer 962 can be formed of the same materials and via similar processes as the first sacrificial layer 960. In some implementations, the first sacrificial layer 960 and the second sacrificial layer 962 can include substantially the same materials, or alternatively can be formed of different materials. While different sacrificial materials might entail a release process with two separate etch processes, preferably the materials are selected for selective removal together by the same etchant. In some implementations, a patterning etchant can select between the two materials while a later release etchant can remove both materials.

As shown in FIG. 10C, the encapsulation layer 945 is then deposited over the second sacrificial layer 962 and a portion of the posts 930c and 930d. The encapsulation layer 945 may also be referred to as the “thin-film encapsulation shell layer” or simply the “shell layer.” The encapsulation layer 945 provides one means for encapsulating the movable mirror 901e within the device 900.

The encapsulation layer 945 can be formed of, for example, SiON, benzocyclobutene (BCB), acrylic, polyimide, silicon oxide, silicon nitride, AlOₓ, aluminum nitride (AlN), combinations thereof, and other similar encapsulating materials known by a person having ordinary skill in the art. The encapsulation layer 945 can be formed by a variety of techniques, such as PECVD or sputtering. In some implementations, the thickness of the encapsulation layer 945 is chosen to be sufficient to protect the electromechanical systems devices from moisture and other contaminants. In some implementations, the thickness of the encapsulation layer 945 can be in the range of about 2,000-50,000 Å. In other implementations, the encapsulation layer 945 is about 10,000 Å thick.

The encapsulation layer 945 can be patterned to include orifices over a plurality of anchor regions. For example, as shown in FIG. 10C, the encapsulation layer 945 includes the orifice 935 located over the anchor region 923c. The orifices in the encapsulation layer 945 can be sized and shaped to allow the sacrificial material 960 and 962 to be released. The orifices can be included in a release path, which allows both the first sacrificial layer 960 and the second sacrificial layer 962 to be etched, thereby releasing the movable mirror 901e to move freely within the gap 917 and the gap 919.

In some implementations, the orifice 935 can be circular or annular, however, other geometric orientations are also possible. The orifices 935 can have a width or diameter in the range of about 2-10 μm. In some implementations, the orifice 935 may be roughly circular in shape and have a diameter of about 3 μm. In some implementations, the orifice 935 may be roughly circular in shape and have a diameter of about 7 μm. After release, the orifice 935 can be used to create a desired environment for the IMOD or similar electromechanical systems devices. For example, a substantial vacuum or low pressure environment can be established through the orifice. For an array of MEMS devices, a plurality of orifices like orifice 935 can allow etchants to have access to sacrificial materials inside the MEMS devices.

After the encapsulation layer 945 is deposited, the first sacrificial layer 960 and the second sacrificial layer 962 can be removed as illustrated in FIG. 10D. As discussed above, the sacrificial layers 960 and 962 can be etched through the release path formed by the orifices, for example though orifice 935. In forming the structure shown in FIG. 10D a portion of the second sacrificial layer 962 is removed first. This removal of a portion of the second sacrificial layer 962 can help create a release passage for removal of the first sacrificial layer 960.

After the first and second sacrificial layers 960 and 962 have been removed, the movable mirror 901e is spaced from the substrate 950 by a gap 919. The movable mirror 901e can be supported by the posts 930c and 930d such that the gap 919 is maintained from the optical stack 916. The gap 919 roughly corresponds to the thickness of the removed first sacrificial layer 960, although a “launch effect” from internal tension and interaction with support structures can cause an upward, or downward, deviation. A channel length C_{L} can be defined as the distance from the edge of an orifice (for example, orifice 935) to a location of the movable mirror (for example, movable mirror 901e) directly above the edge of a first gap (for example, gap 919). In some implementations the channel length C_{L} can be on the order of several microns, for example, about 2 μm or greater.

In addition, after the first and second sacrificial layers 960 and 962 have been removed, the encapsulation layer 945 is spaced from the movable mirror 901e by a second gap 917. The encapsulation layer 945 is supported by the encapsulation support 958. Thus, the encapsulation support 958 can help support the encapsulation layer 945 over the movable mirror 901e below. The encapsulation support 958 can also add to the rigidity and structural integrity of the completed encapsulated IMOD device 900. As shown in FIG. 10D the encapsulation support 958 is roughly shaped as a funnel shape, or inverted cone, but the encapsulation support 958 may be any suitable shape.

After the device 900 has been released, the sealing layer 902 is deposited over the encapsulation layer 945 to produce the device shown in FIG. 9C. The sealing layer 902 also can be a conformal layer or a thin film. The sealing layer 902 can be formed by, for example, PVD, spin-on glass (SOG), ALD, PECVD and/or thermal CVD processes. The sealing layer 902 can be formed with a sealing material. Suitable sealing materials may include, for example, dielectric materials, metals, polymers, or hermetic polymers. In some implementations, the sealing material is SiON. As shown in FIG. 9C, the sealing layer 902 can plug the orifices, for example, orifice 935. In some implementations, the encapsulation layer 945 with sealed orifices forms a hermetic seal for the electromechanical systems devices. The sealing layer 902 can also add to the structural rigidity of the encapsulation layer 945 by filling in the sealant troughs 972a-972d in the encapsulation layer 945 as shown in FIG. 9A.

In some implementations, the sealing layer 902 is planarized after deposition to remove topographical irregularities in the sealing layer 902. The planarization process may include, for example, mechanical polishing, chemical mechanical planarization, or a spin-coating process. In some implementations, the seal layer 902 has a thickness in the range of about 5,000-50,000 Å. In some implementations, the seal layer 902 is about 30,000 Å thick.

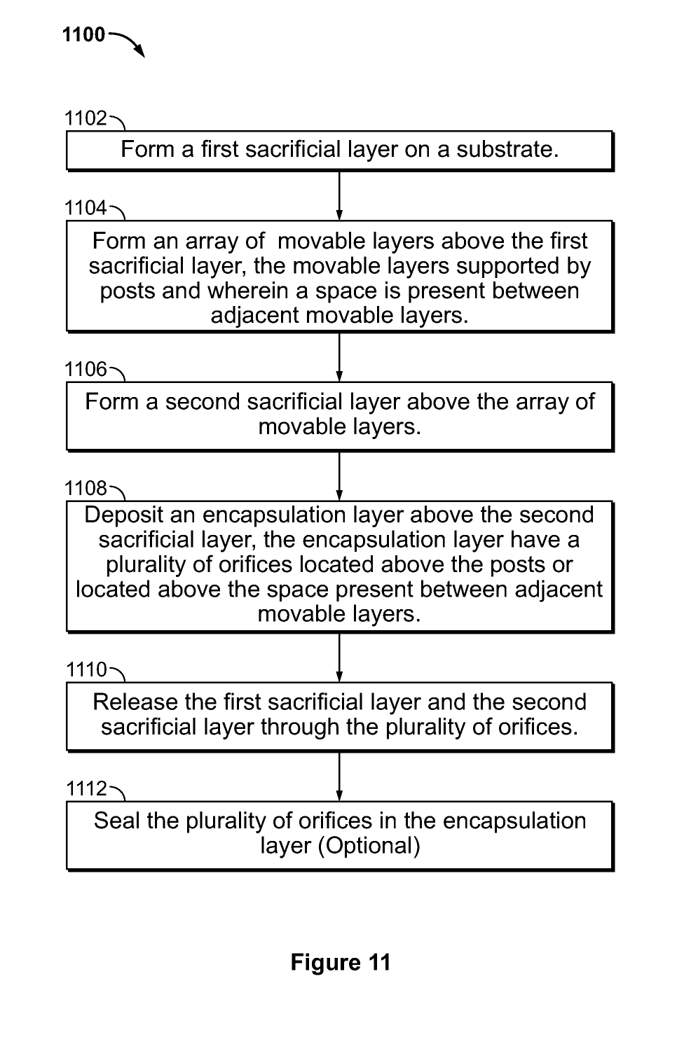

FIG. 11 shows an example of a flow diagram illustrating a manufacturing process for forming an encapsulated array of electromechanical systems devices. The process 1100 begins at block 1102 by forming a first sacrificial layer on a substrate as discussed above. The process 1100 then moves to block 1104 to form an array of movable layers above the first sacrificial layer. The movable layers can be supported from below by posts, or the movable layers can be self-supporting. A space can be present between adjacent movable layers. The process 1100 then moves to block 1106 wherein a second sacrificial layer is formed above the array of movable layers. The process 1100 then moves to block 1108 to deposit an encapsulation layer above the second sacrificial layer. The encapsulation layer can have a plurality of orifices located above the posts or located above the space between adjacent movable layers. The process 1100 the moves to block 1110 release the first sacrificial layer and the second sacrificial layer through the plurality of orifices. Optionally, the process 1100 moves to block 1112 by sealing the plurality of orifices in the encapsulation layer.

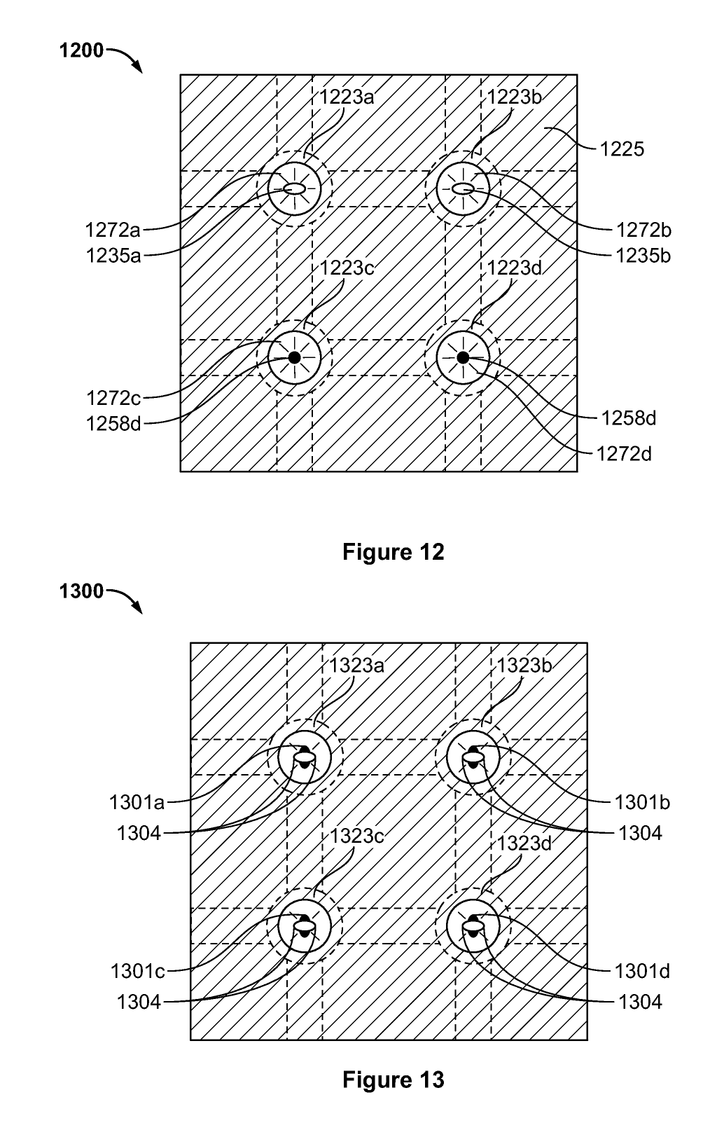

FIG. 12 shows an example top view schematic illustration of a portion of an alternate implementation of an interferometric modulator device 1200. The interferometric modulator device 1200 includes a plurality of sealant troughs 1272a-1272d formed in a sealing layer 1225. However, in this implementation the sealant troughs 1272a-1272d are formed in a pattern having alternating rows of either sealed orifices or encapsulation layer anchors within the sealant troughs 1272a-1272d and over anchor regions 1223a-1223d. As illustrated, the device 1200 includes an encapsulation layer having entire rows or entire columns containing either a sealed orifice (for example, sealed orifices 1235a and 1235b) or an encapsulation layer anchor (for example, encapsulation layer anchors 1258a and 1258b) exclusively. In some implementations, the arrangement of the encapsulation layer anchors and sealed orifices are arranged over the anchor areas in a similar pattern or in a random pattern across the array.

For example, as shown in FIG. 9A, some implementations include an alternating pattern of orifices such that every other sealant trough includes a release orifice. In this way, the encapsulation anchors and orifices are positioned in an alternating pattern across the rows of anchor regions. Thus, the encapsulation anchors and orifices are located along alternating diagonal lines across an array of pixels. In some implementations, every third, fourth, or fifth sealant trough includes an orifice.

FIG. 13 shows an example top view schematic illustration of a portion of an interferometric modulator device 1300 including an array of encapsulated interferometric modulators. The interferometric modulator device 1300 includes a plurality of sealant troughs 1372a-1372d formed in a sealing layer 1225. In this implementation, the sealant troughs 1372a-1372d contact and support the encapsulation layer and further include one or more orifices disposed within sealant troughs 1372a-1372d. As shown, the device 1300 includes sealant troughs 1372a-1372d formed on the anchor areas 1323a-1323d. The sealed orifices 1304 occupy roughly the same space as the anchors 1301a-1301d. Including encapsulation layer supports over each anchor region can increase the rigidity and structural integrity which may be desirable in some implementations.

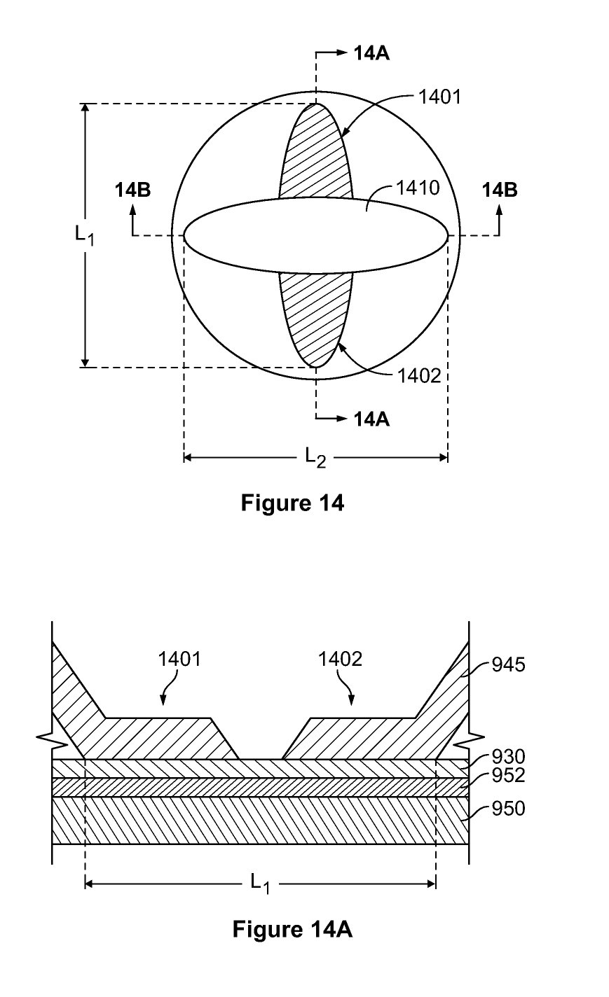

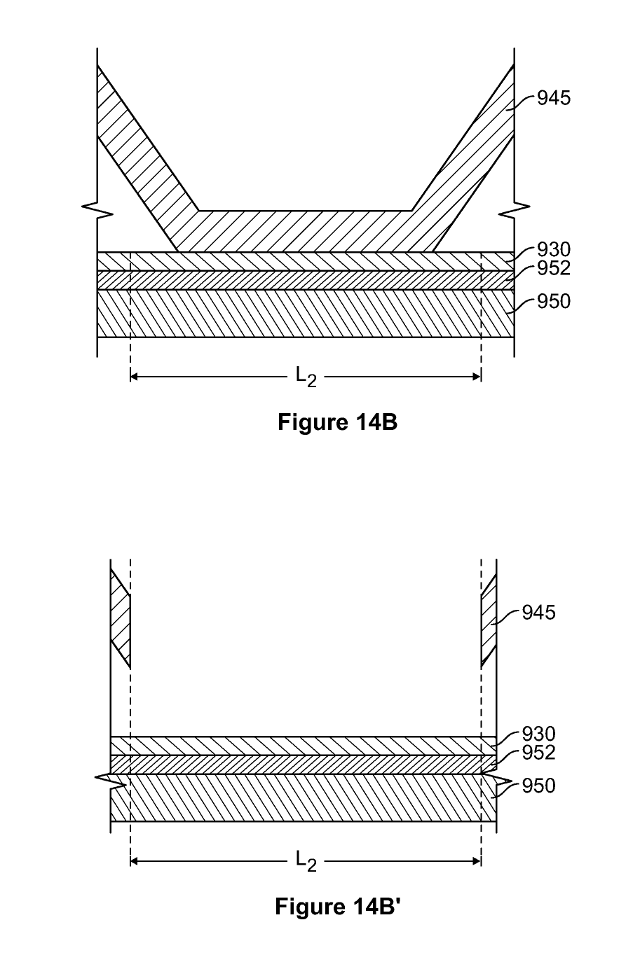

FIG. 14 shows an example enlarged top view schematic illustration of a portion of an anchor area of the interferometric modulator device in FIG. 13. As illustrated, the device can include an encapsulation layer anchor formed by an encapsulation layer that contacts at least a portion of the anchor area and/or pixel post at contact areas 1401 and 1402 along a first length L₁. An orifice can then be etched in the encapsulation layer along a second length L₂. The electromechanical devices can be released through the orifice and the orifice can be sealed by the sealant layer as discussed above. In this way, the device may be less susceptible to misalignment errors. Thus, if the orifice is etched in a position slightly off center from the anchor area, the sealant layer can still be deposited without damaging the mechanical portions of the electromechanical device below.

FIG. 14A shows an example cross-section of a portion of an anchor area of the interferometric modulator device across the line 14A-14A after etching the orifice. FIG. 14B shows an example cross-section of a portion of an anchor area of the interferometric modulator device across the line 14B-14B before etching the orifice. FIG. 14B′ shows an example cross-section of a portion of an anchor area of the interferometric modulator device across the line 14B-14B after etching the orifice.

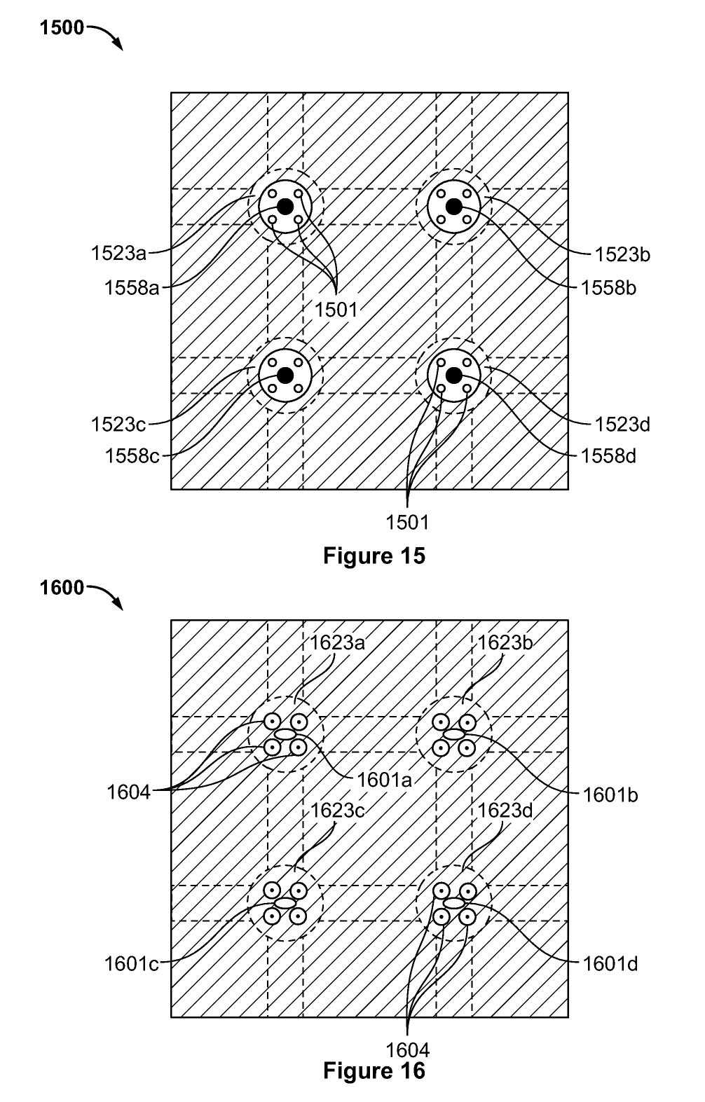

FIG. 15 shows an example top view schematic illustration of a portion of an interferometric modulator device 1500 including an array of encapsulated interferometric modulators. As shown, the device 1500 includes an encapsulation layer having four sealed orifices 1501 offset from each encapsulation layer anchor 1558a-1558d and over each anchor region 1523a-1523d. Thus, the encapsulation layer forms an encapsulation layer anchor at each post, and further includes offset orifices 1501 in the encapsulation layer that allow release gas to enter the interferometric modulator device 1500. One having ordinary skill in the art can appreciate that more or less orifices may be included to optimize release times depending on the type of the electromechanical systems devices that are encapsulated. Further the orifices may be located over the anchor regions in a variety of different patterns. For example, in some implementations, the orifices 1501 may be located in a diamond pattern over the anchor regions 1523a-1523d. In some implementations, the orifices 1501 are located in a pattern rotated 45° from the pattern shown in FIG. 15.

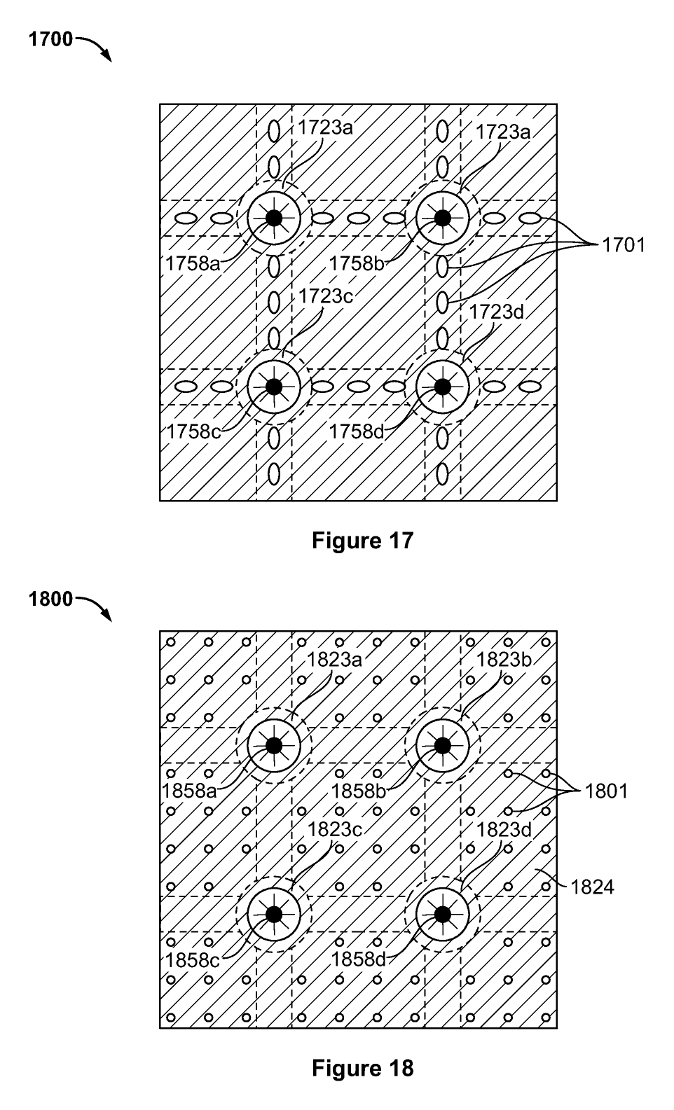

FIG. 16 shows an example top view schematic illustration of a portion of an interferometric modulator device 1600 including an array of encapsulated interferometric modulators. The device 1600 includes an encapsulation layer having four encapsulation layer anchors 1604 and a set of sealed orifices 1601a-1601d over each anchor region 1623a-1623d. One having ordinary skill in the art can appreciate that more or fewer encapsulation layer anchors may be included depending on desired physical and optical properties. Further encapsulation layer anchors may be located over the anchor regions in a variety of different patterns. For example, in some implementations, the encapsulation layer anchors 1604 may be located in a pattern rotated 45° from the pattern shown in FIG. 16.

FIG. 17 shows an example top view schematic illustration of a portion of an interferometric modulator device 1700 including an array of encapsulated interferometric modulators. The device 1700 includes encapsulation layer anchors 1758a-1758d located over anchor regions 1723a-1723d, respectively. In addition, a plurality of sealed orifices 1701 are located over optically inactive regions of the interferometric modulator device 1700, such as in between movable mirrors of the interferometric modulator device 1700. Thus, in this implementation, the orifices for introducing the release gas are positioned in the spaces located between each movable mirror. Because these spaces are not optically active regions, introduction of release gasses through these orifices may reduce the likelihood that release gas, or subsequent sealing material would disadvantageously affect operation of the device compared to orifices formed over the mirror regions. Furthermore, sealant material deposited over orifices positioned over optically inactive regions reduces the likelihood that the sealant will damage the movable mirrors or cause the movable mirrors to be pinned in one position.

FIG. 18 shows an example top view schematic illustration of a portion of an interferometric modulator device 1800 including an array of encapsulated interferometric modulators. The interferometric modulator device 1800 includes encapsulation layer anchors 1858a-1858d disposed over anchor regions 1823a-1823d. A set of sealed orifices 1801 are located in a sealant layer 1824 in a predetermined spatial pattern across the entire array of movable mirrors, including, for example, over optically active regions. In this implementation, directional deposition techniques may be used to ensure that the seal material used to seal the orifices is not deposited on to the mechanical layer below. One having ordinary skill in the art will recognize that similar arrangements of encapsulation layer supports and orifices may be placed over the anchor regions in a number of different patterns to optimize the desired rigidity and fabrication process times, all such implementations are contemplated by this disclosure.

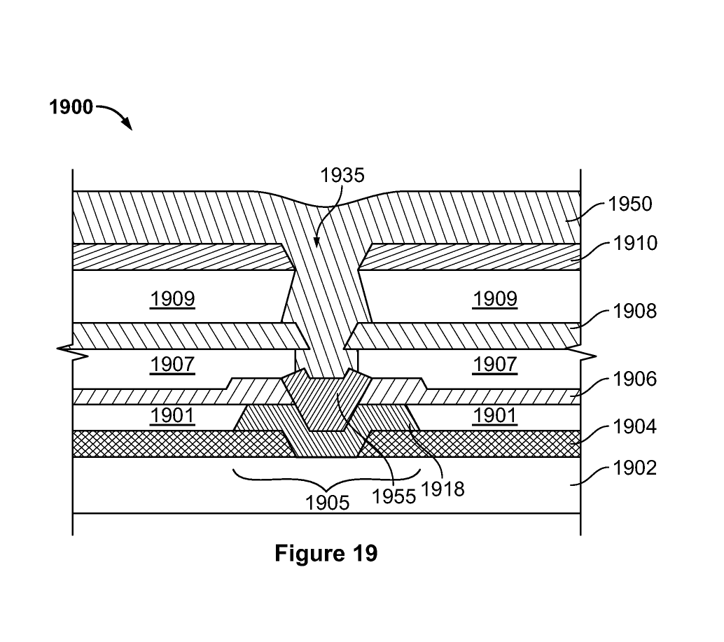

FIG. 19 shows a partial cross-sectional schematic illustration of an encapsulated two-electrode interferometric modulator device 1900. One having ordinary skill in the art will recognize that the encapsulation methods and devices disclosed herein may also be applied to two-electrode IMOD devices. As shown in FIG. 19 and similar to the IMODs described above, a movable mirror layer 1906 is spaced apart from a stationary electrode 1904 by a gap 1901 and supported below by a post 1918 in an anchor region 1905.

A second stationary electrode 1908 is spaced apart from the movable mirror 1906 by a second gap 1907. The movable mirror layer 1906 can move towards the first stationary electrode 1904 and/or the second stationary 1908 electrode upon an applied voltage. Additional anchor structure 1955 can further anchor the movable mirror 1906 and/or provide a receiving space for a seal layer 1950. An encapsulation layer 1910 is spaced apart from the second stationary electrode 1908 by a third gap 1909. In some instances the third gap 1909 is not present and the encapsulation layer 1910 and second stationary electrode 1908 function as one layer. The encapsulation layer 1910 has at least one orifice 1935. The orifice 1935 provides a release path for sacrificial materials removed during fabrication of the two-electrode IMOD. The encapsulation layer 1910 may also be supported from below by encapsulation layer supports (not-shown) as discussed above. The seal layer 1950 is disposed over the encapsulation layer 1910, sealing the orifice 1935. The seal material may be deposited on at least a portion of the optically inactive areas of the IMOD device including for example, the anchor regions 1905, the post 1918, the additional anchor structure 1955, and/or the second stationary electrode 1908.

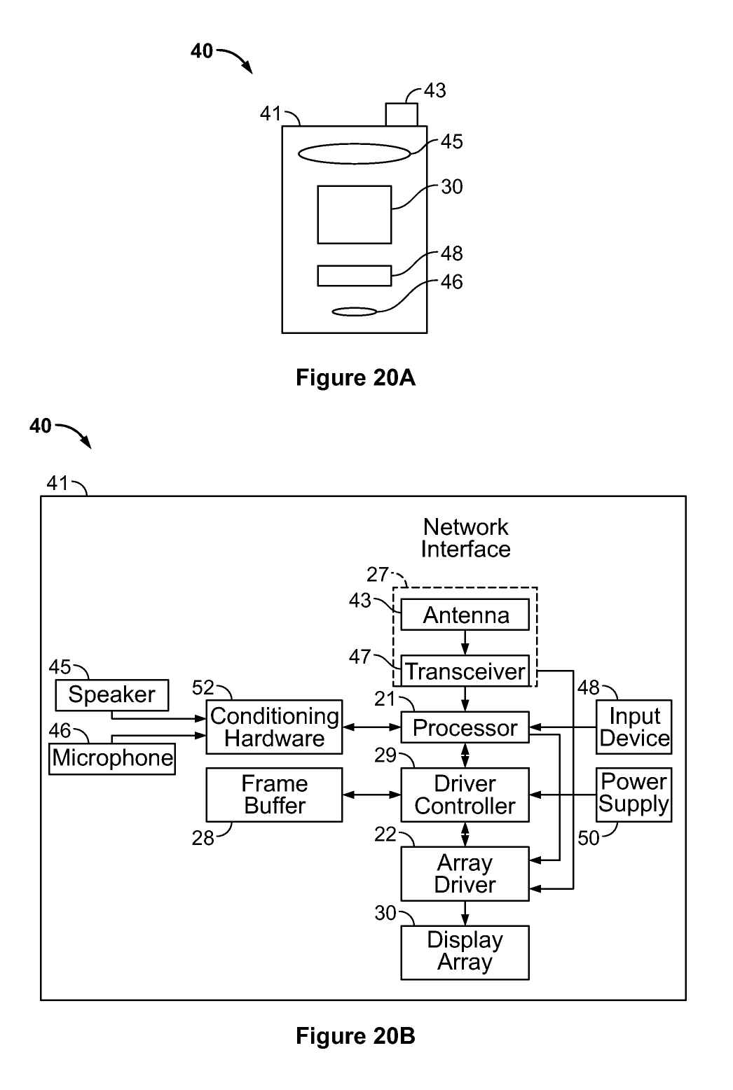

FIGS. 20A and 20B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 20B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems device package, comprising:
a substrate;
an array of movable electrodes spaced apart from the substrate by a first gap and suspended above the substrate by a plurality of posts, wherein a space is present between adjacent movable electrodes in the array;
an encapsulation layer spaced apart from the array of movable electrodes by a second gap and including a plurality of orifices positioned over one of the plurality of posts and the space between adjacent movable electrodes; and
a sealing layer disposed over the encapsulation layer and sealing the orifices.

2. The device package of claim 1, wherein the plurality of orifices are positioned over the plurality of posts.

3. The device package of claim 1, wherein the plurality of orifices are positioned over the space between adjacent movable electrodes.

4. The device package of claim 1, wherein the posts are disposed in center areas of anchor regions and wherein each anchor region is configured to support at least one post.

5. The device package of claim 4, wherein at least one orifice is adjacent to each post.

6. The device package of claim 5, wherein four orifices are adjacent to each post.

7. The device package of claim 1, wherein the plurality of posts are arranged into an array of rows and columns.

8. The device package of claim 7, wherein the plurality of orifices are positioned over alternating posts in the array.

9. The device package of claim 1, wherein the device is an interferometric modulator device.

10. The device package of claim 9, wherein the space between adjacent movable electrodes is an optically inactive space between adjacent movable electrodes.

11. The device package of claim 1, wherein the sealed orifices have a width of about two microns or greater and the second gap has a height of about 0.75 microns or less.

12. The device package of claim 1, wherein the second gap has a height of about 7,500 Angstroms.

13. The device package of claim 1 wherein a thickness of the sealing layer at the orifices is about two microns or greater.

14. The device of claim 1, further comprising:
a display that includes the array of movable electrodes;
a processor that is configured to communicate with the display, the processor being configured to process image data; and
a memory device that is configured to communicate with the processor.

15. The device as recited in claim 14, further comprising:
a driver circuit configured to send at least one signal to the display.

16. The device as recited in claim 15, further comprising:
a controller configured to send at least a portion of the image data to the driver circuit.

17. The device as recited in claim 14, further comprising:
an image source module configured to send the image data to the processor.

18. The device as recited in claim 17, wherein the image source module includes at least one of a receiver, transceiver, and transmitter.

19. The apparatus as recited in claim 14, further comprising:
an input device configured to receive input data and to communicate the input data to the processor.

20. A method of forming an electromechanical systems device package, comprising:
forming a first sacrificial layer on a substrate;
forming an array of movable electrodes above the first sacrificial layer, wherein the movable electrodes are supported by posts and wherein a space is present between adjacent movable electrodes;
forming a second sacrificial layer above the array of movable electrodes;
depositing an encapsulation layer above the second sacrificial layer, wherein the encapsulation layer has a plurality of orifices located above the posts or located above the space present between adjacent movable electrodes;
releasing the first sacrificial layer and the second sacrificial layer through the plurality of orifices; and
sealing the plurality of orifices in the encapsulation layer.

21. The method of claim 20, wherein the encapsulation layer has a plurality of orifices located above the posts.

22. The method of claim 20, wherein the encapsulation layer has a plurality of orifices located above the space present between adjacent movable electrodes.

23. The method of claim 20, wherein sealing the orifices includes depositing material through the orifices and onto the anchor regions.

24. The method of claim 20, wherein the movable electrodes are movable mirrors, and the space present between adjacent movable electrodes is an optically inactive region.

25. The method of claim 20, wherein the encapsulation layer has a plurality of orifices located above each of the posts.

26. The method of claim 20, wherein the encapsulation layer has a plurality of orifices located above the posts and a plurality of orifices located above the space present between adjacent movable electrodes.
